(19) United States
(12) Patent Application Publication
(10) Pub. No.: US 2010/0084434 A1
(43) Pub. Date: Apr. 8, 2010

(54) AEROSOL REACH EXTENDING HANDLE

(76) Inventor: Dean L. Rhoades, Beverly Hills, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/247,946

(22) Filed: Oct. 8, 2008

(51) Int. Cl. B67D 5/64; B65D 83/00; B65D 83/16

(52) U.S. Cl. 222/162; 222/473; 222/174; 222/402.15

(57) ABSTRACT

An apparatus for extending the reach of a dispenser is disclosed. The apparatus is configured to secure a dispenser so that an activation mechanism of the apparatus causes a release mechanism of the dispenser to trigger. When the release mechanism of the dispenser is triggered, content contained in the dispenser is released from the dispenser and through an opening of the apparatus. The activation mechanism is positioned on the apparatus to extend the normal reach of the dispenser. Therefore, a user can easily apply body products to hard-to-reach areas of the body.

### BACKGROUND

1. Field of the Invention

Embodiments of the present invention relate to an apparatus for extending the reach of a dispenser. Specifically, the embodiments of the present invention relate to an apparatus for holding and activating a dispenser, where the extended reach is obtained by providing an activation mechanism at a distance from the release point of the dispenser.

2. Description of the Related Art

Body products (e.g., lotion, insect repellent, topical analgesics, sunscreen, etc.) can be contained in simple bottles or jars. However, every time the cap of a bottle or lid of a jar is unscrewed or flipped open, the contents of the bottle or jar are exposed to air. Repeated exposure to air reduces the effectiveness of the product by drying it out. Further, removal of the product by hand from the bottle or jar can contaminate the remaining product in the bottle or jar (since bacteria or particulate matter on a person's hand will transfer to the product in the bottle or jar).

Dispensers with a release mechanism are a more hygienic way of storing and using body products. The release mechanism controls the output of contents so that any portion remaining in the container is not freely exposed to air and does not come into contact with contaminants until it is released from the container. One example of a release mechanism is an aerosol spray nozzle. To cause contents to spray from an opening in the nozzle, a user presses down on the nozzle. The nozzle opens a valve assembly and releases the product pressurized within the container with gas. The gas maintains the pressure in the can and when released, evaporates to produce a misting of the product emerging from the can. Examples of products are hairspray, deodorant, and paint. The contents can spray continuously (e.g., for as long as the user holds the nozzle down) or for a brief period of time (e.g., each press of the nozzle corresponds to a single burst of product).

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a diagram of an exterior view of one embodiment of an extended reach apparatus being held by a user.

FIG. 2 is a diagram of a cross-sectional view of one embodiment of an extended reach apparatus.

FIG. 3 is a diagram of a bottom view of one embodiment of an extended reach apparatus head.

FIG. 4 is a block diagram of one embodiment of an extended reach apparatus.

### DETAILED DESCRIPTION

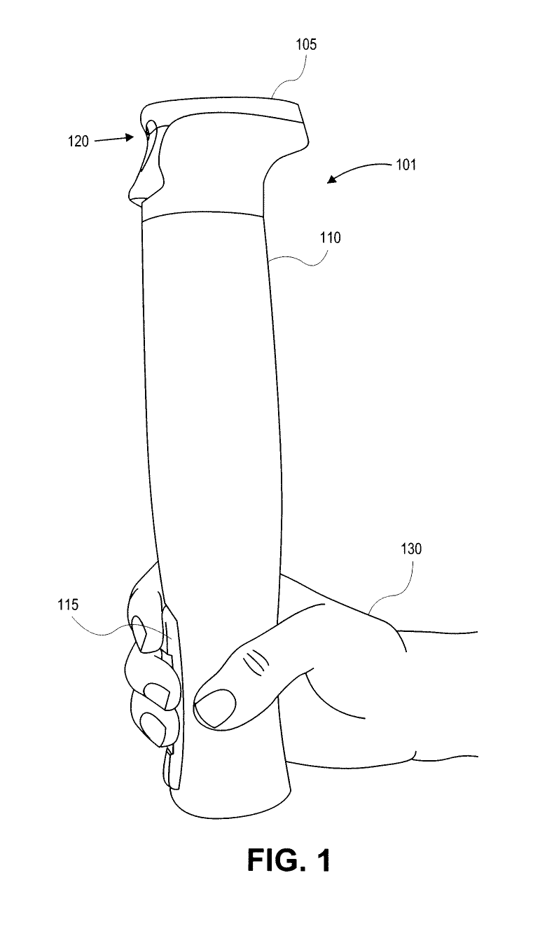

FIG. 1 is a diagram of an exterior view of one embodiment of an extended reach apparatus being held by a user. The apparatus is configured to secure a dispenser equipped with a release mechanism (e.g., a spray nozzle). The apparatus has a housing 101 that holds the dispenser in position and an activation mechanism 115 that causes the release mechanism of the dispenser to release contents from the dispenser through an opening 120 of the apparatus. The dimensions and shape of the apparatus allow a user to easily hold and operate the apparatus with a single hand 130. FIG. 1 illustrates a user's hand 130 grasping a body 110 and activation mechanism 115 of the apparatus.

The extended reach apparatus includes an activation mechanism 115 and housing 101. In one embodiment, the housing 101 is divided into a body 110 and a head 105. In another embodiment, the housing 101 has an integrated design. The housing 101 secures a dispenser in relation to the activation mechanism 115. The housing 101 can secure the dispenser through a form fit, attachment mechanism, receiving channel, interior chamber, or similar structure. In one example embodiment, the housing 101 defines an interior chamber to receive the dispenser in the body 110 and encloses an open end of the chamber with the head 105. The housing 101 can have any size, shape, or dimensions. The housing 101 can have a roughly cylindrical and elongated shape. The length of the housing can be between three and twenty inches. The width and/or depth or diameter of the housing can be between one and six inches. The housing can be formed from resin, metal, plastic, fiberglass, or similar materials or combinations thereof. Each piece of the apparatus can be made of the same or different materials for reasons relating to consumer preferences, durability, aesthetic, practicality, cost, or similar factors.

The body 110 is a substantial portion of the housing 101. In one embodiment, the body 110 fully encloses the dispenser in a chamber so that the dispenser cannot be viewed from outside the apparatus. In another embodiment, the body 110 is not a solid piece of material, but includes holes or is made up of pieces of material so that one can determine whether a dispenser is secured inside the apparatus by an external view of the apparatus. In a further embodiment, the body 110 can include a covered or uncovered opening in the side to allow a user to insert a dispenser into the apparatus and to remove the dispenser from the apparatus. For example, the dispenser can be inserted and snapped into place from the side of the body and secured by a set of fasteners in a channel-like manner. A “set,” as used herein, refers to any whole number of items including one item. The body 110 can be shaped so that a user can comfortably grasp a portion of the body 110. For example, in some embodiments, the body 110 is cylindrical (as illustrated), curved, S-shaped, or angular. Further, the body 110 can have a smooth or bumpy surface and can vary in color, design or opaqueness.

In one embodiment, the head 105 is detachable from the body 110 to allow access to an interior chamber or similar securing mechanism or structure. In one embodiment, the head 105 is an end piece cap with an internal complementary shape to receive a nozzle. In another embodiment, the head 105 is a cap with curved sides and a ceiling to accompany the body 110. The head 105 can be threaded to fit a reciprocally threaded body 110. To insert or remove a dispenser from the apparatus, one can unscrew, snap, slide, or otherwise detach the head 105 from the body 110. In another embodiment, the head 105 is not detachable from the body and the dispenser can be inserted to or removed from another opening of the apparatus (such as through an opening of the body 110). While FIG. 1 depicts an opening 120 in one direction, the head 105 can be positioned so that the opening 120 is pointing in another direction. The opening 120 can also be angled towards or away from the body 110. The head 105 can vary in size and shape as well.

The activation mechanism 115 is coupled to the body 110. A portion of the activation mechanism 115 is external to the body 110 and therefore can be activated by contact with a user's hand 130. The external portion of the activation mechanism 115 can be as large as the length of the entire housing or as small as a single point. The activation mechanism 115 can be made of the same material as the housing 101 or of a different material based on resin, metal, plastic, fiberglass, or similar materials or combinations thereof. To activate the activation mechanism 115, the hand 130 can squeeze the apparatus to depress the external portion of the activation mechanism 115. While the figure depicts fingers in contact with the activation mechanism 115, the hand 130 can be shifted so that another part of the hand 130 (e.g., the palm of the hand) is in contact with the activation mechanism 115. The squeezing motion causes contents of the dispenser to emit through the opening 120 of the head 105 of the apparatus. The head 105 and dispenser are positioned so that the opening of the nozzle aligns with the opening 120 of the head. The activation mechanism 115 can be configured to activate in other manners as appropriate, such as by sliding, rotating, twisting, touching, tapping, or other similar contact.

When the dispenser is secured in place, activation of the activation mechanism 115 causes the dispenser to move and release contents from the dispenser through the opening 120 of the apparatus. The dispenser can include a nozzle that releases contents when the nozzle is pressed downwards. One example of a dispenser is an aerosol spray can for self-tanning lotion, moisturizing lotion, sunscreen, hairspray, or similar products. Another example is an aerosol or non-aerosol dispenser for foam or gel soap, shaving products, or similar products. In these examples, the area of the dispenser one has to press or touch to release the product is in close proximity to the opening of the dispenser where the product is emitted. For instance, one can press downwards on a nozzle to cause the product to spray or foam from the nozzle.

The activation mechanism 115 is positioned away from the opening 120 of the apparatus (and nozzle of the dispenser) to thus extend the reach of the dispenser. As illustrated, the activation mechanism 115 and opening 120 can be positioned at opposite ends of the apparatus. Rather than touching the nozzle of the dispenser to release its contents through the nozzle, one can touch the activation mechanism 115 at the bottom end of the apparatus to release the dispenser's contents through the nozzle (and also through the opening 120 at the top end of the apparatus). The distance between the activation mechanism 115 (at a proximal end of the apparatus) and the opening 120 (and nozzle) (at a distal end of the apparatus) is the distance that the apparatus extends the reach of the dispenser. This distance can be any length from three to twenty inches. Therefore, use of the apparatus extends the reach of the dispenser between roughly three to twenty inches. The apparatus can be used to dispense the product on the back or legs of a user without the user uncomfortably twisting and straining his back, arms, or wrists to reach those areas.

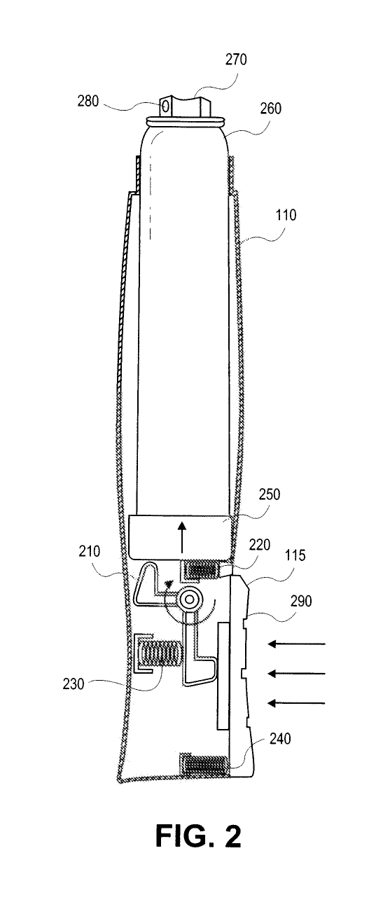

FIG. 2 is a diagram of a cross-sectional view of one embodiment of an extended reach apparatus. This illustration depicts the internal structure of an apparatus with a dispenser 260 (having a nozzle 270) in place. Although this embodiment of the apparatus appears to be perfectly sized for the dimensions of the dispenser 260, the apparatus can also be configured to accommodate dispensers of varying sizes using adjustable or tiered place holders to secure dispensers of different lengths, widths, and nozzle shapes and sizes.

FIG. 2 depicts the view of half of body 110. The body 110 can be manufactured in two or more pieces or it can be manufactured as a single integral piece, either including or not including the head. The body 110 is in contact with an activation mechanism 115 and a displacement mechanism 250 to secure and move the dispenser 260 in a controlled manner.

In one example embodiment, the activation mechanism 115 includes an external contact 290, a rotating mechanism 210 and three springs 220, 230, 240. The springs 220, 230, 240 can be metal, plastic, or other similar material. Other embodiments can include a fewer or greater number of springs. The external contact of the activation mechanism 290 initializes operation of the apparatus when activated by a user. The external contact of the activation mechanism 290 is in contact with springs 220 and 240. When in a rest position, springs 220 and 240 are in an expanded position to bias the external contact of the activation mechanism 290 in the position illustrated (slightly protruding from the exterior surface of the body 110). Thus, the size of the springs 220 and 240 should be scalable to the size of the apparatus. When the external contact of the activation mechanism 290 is inwardly depressed (with an inward force in the direction of the three arrows depicted), the external contact of the activation mechanism 290 moves the rotating mechanism 210 in the direction of the clockwise arrow by transferring the force from the external contact of the activation mechanism 290 to the rotating mechanism 210 at the point of contact between them.

The rotating mechanism 210 can be formed with two arms that rotate at an axis point. The rotating mechanism 210 is in direct contact with the external contact of the activation mechanism 290, spring 230, the housing 101, and the displacement mechanism 250. Spring 230 contracts and expands to guide the rotating mechanism 210 between two positions, a resting position and a non-resting position. The resting position of the rotating mechanism 210 is slightly in a counterclockwise position as compared to the non-resting position when viewed from the direction of FIG. 2. When the apparatus is not activated, spring 230 sits at the resting position and biases the rotating mechanism 210 to rest at the position shown in FIG. 2. The size of spring 230 should also be scalable to the size of the apparatus. In one embodiment, spring 230 is larger than springs 220 and 240. In other embodiments, spring 230 can not be larger than springs 220 and 240 or can comprise of multiple springs. The clockwise movement of the rotating mechanism 210 causes the upper part of the rotating mechanism 210 to move the displacement mechanism 250 through direct contact.

In other embodiments, the activation mechanism 115 can use other configurations and parts to facilitate movement of the displacement mechanism 250. The activation mechanism 115 can shift the displacement mechanism in any manner necessary. For example, the activation mechanism 115 can use a motorized configuration. The motorized configuration can be activated by an external touch or movement by a user to activate a lifting motion of the displacement mechanism 250. For example, when a user presses a button, the button can turn on a motor that causes a piece to move and push against the displacement mechanism 250, in turn causing the displacement mechanism 250 to move.

The displacement mechanism 250 is thus shifted in a generally upward direction towards the nozzle 270 or head (not shown) of the apparatus as indicated by the arrow. The displacement mechanism 250 can be a formed piece that fits the bottom of a dispenser. In other embodiments, the displacement mechanism 250 can be a larger or smaller piece that provides movement and support for the dispenser. The displacement mechanism 250 moves on a straight axis along the length of the apparatus. In one embodiment, the displacement mechanism 250 includes ridges that fit to complementary railings of the internal portion of the body 110 in a tongue and groove configuration. The ridges allow the displacement mechanism 250 to slide along the railing in the proper direction (i.e., towards the nozzle/head) with minimal friction. Otherwise, the displacement mechanism 250 can tilt or get stuck within the body 110 and lose its effectiveness to move the dispenser 260.

The dispenser 260 is a container with a nozzle 270. The nozzle 270 causes the product to spray or foam when released from the dispenser through the opening 280. The nozzle 270 opens an internal valve that allows gas pressurized liquid to release from the dispenser 260. Activating the nozzle 270 involves pressing downwards on the nozzle 270. The dispenser 260 can range in height and width. A height of the dispenser 260 can range from three to twenty inches. A width of the dispenser 260 can range from one to six inches. If the width of the dispenser is so large as to be uncomfortable for the user to grasp with a hand, the apparatus can assist in scaling down the width by extending the width and allowing the user to grasp the portion of the apparatus that does not directly encompass the dispenser. In one embodiment, the dispenser 260 can be specially made to fit a particular apparatus. For example, the apparatus can completely encompass the dispenser so that the dispenser is fully disposed inside the housing of the apparatus. In another embodiment, the dispenser 260 can be separately manufactured without the apparatus in mind, yet can be appropriately used with the apparatus. For example, a line of apparatuses can be manufactured of different shapes and sizes. In another example, expansion or reduction pieces or inserts can be added or removed to the interior portion of the apparatus to accommodate dispensers of many sizes and shapes. Furthermore, the dispenser 260 can be non-removable or removable from the apparatus, which is reusable. If the dispenser 260 is not removable, then when the product is depleted, more product must be added directly to the dispenser while remaining within the apparatus. If the dispenser 260 is removable, then replacement dispensers can be purchased to continually replace old dispensers. Thus, the dispensers would be characterized as interchangeable, disposable, and replaceable.

Since the dispenser 260 is in contact with the displacement mechanism 250, the dispenser moves in the same direction together with the displacement mechanism 250. The distance shifted by the displacement mechanism 250 is thus the same distance shifted by the dispenser 260. When the dispenser 260 is moved, the nozzle 270 comes into contact with the head of the apparatus. Since the head of the apparatus is secured in place and does not move, the nozzle 270 has no choice but to depress against the internal wall of the head. Note that the direction the nozzle 270 depresses is perpendicular or generally perpendicular to the movement of the external contact of the activation mechanism 290. Depressing the nozzle 270 activates the release of content from the container 260 through the opening of the nozzle 280. The opening of the nozzle 280 is aligned with the opening of the head (not shown) so that contents are emitted from the apparatus and onto a targeted area. A typical nozzle or release mechanism 270 only needs to be depressed approximately 0.02 inches to release contents from the dispenser 260. Thus, the displacement mechanism 250 and the dispenser 260 need only be shifted upward by approximately 0.02 inches for the apparatus to be effective. Such distance can be accomplished with minimal force. The apparatus can provide for a dispenser displacement of any distance necessary for the nozzle to depress. Such displacement depends on factors, such as type of nozzle and type of release mechanism. The distance can be adjustable to accommodate dispensers of various types.

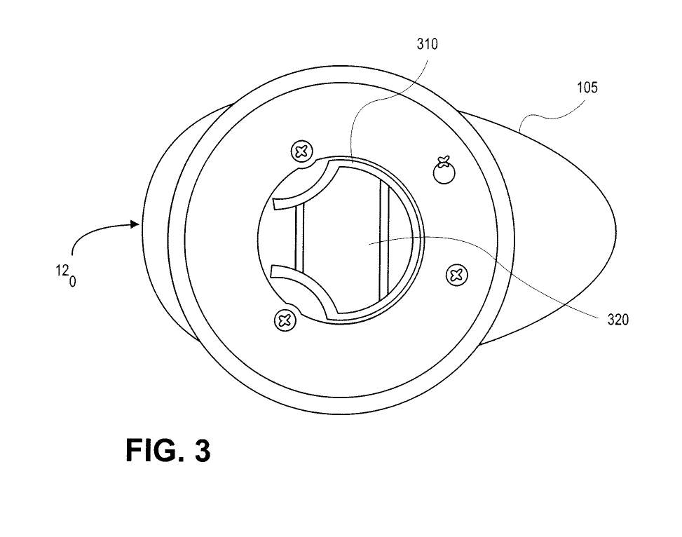

FIG. 3 is a diagram of a bottom view of one embodiment of an extended reach apparatus head 105. The head 105 is attached to a body of the apparatus to secure and enclose a dispenser. The head 105 aligns the dispenser so that the opening of the dispenser corresponds with the opening of the head 120. The head 105 also acts as a barrier for the dispenser when the dispenser is moving. The upper interior wall 320 of the head 105 prevents the dispenser from moving past a certain point, thus forcing the nozzle of the dispenser that is in contact with the head 105 to depress, releasing content from the dispenser.

The head 105 includes a form fitting recess 310 that secures the nozzle of the dispenser in a single orientation. The opening of the nozzle of the dispenser is thus directed towards the opening of the head 120. Therefore, contents that are emitted from the dispenser travel through the opening of the head 120, instead of being blocked by the internal side walls of the head and remaining inside the apparatus.

The form fitting recess 310 is made of one or more pieces to complement the shape of a nozzle. The form fitting recess 310 can be configured to secure a single shape of nozzle. The form fitting recess 310 can also be configured to secure nozzles of varying types and sizes. One can interchange heads and bodies of the apparatus to customize a fit for the dispenser. The length of the form fitting recess 310 need not extend to the entire length of the nozzle. The length of the form fitting recess 310 need only be enough to guide the nozzle into position, and therefore can be on the order of a few millimeters.

In one embodiment, the form fitting recess 310 allows for the nozzle of the dispenser to be keyed to the head 105. As used hereinafter, keying refers to a fit such that the nozzle and the head 105 are shaped complementary to each other and so that the head 105 orients the nozzle in a single direction and position when disposed within the apparatus. Therefore, the head 105 is keyed for a limited shape and size of nozzle. If a nozzle is not of a particular shape and size, then the nozzle will not fit in the form fitting recess 310 of the head. Further, the keying of the head 105 and nozzle ensures that the contents of the dispenser are released such that they are directed through the opening of the housing.

The upper interior wall 320 of the form fitting recess 310 comes into contact with the top of the nozzle when the dispenser is moved. When the head 105 is attached to the remainder of the apparatus, the head 105 does not move. Accordingly, when the dispenser is shifted towards the head and the head prevents the dispenser from moving any further, the nozzle compresses against the upper interior wall 320 of the form fitting recess 310. This movement of the nozzle releases content from the dispenser and through the appropriately aligned opening 120 of the head 105.

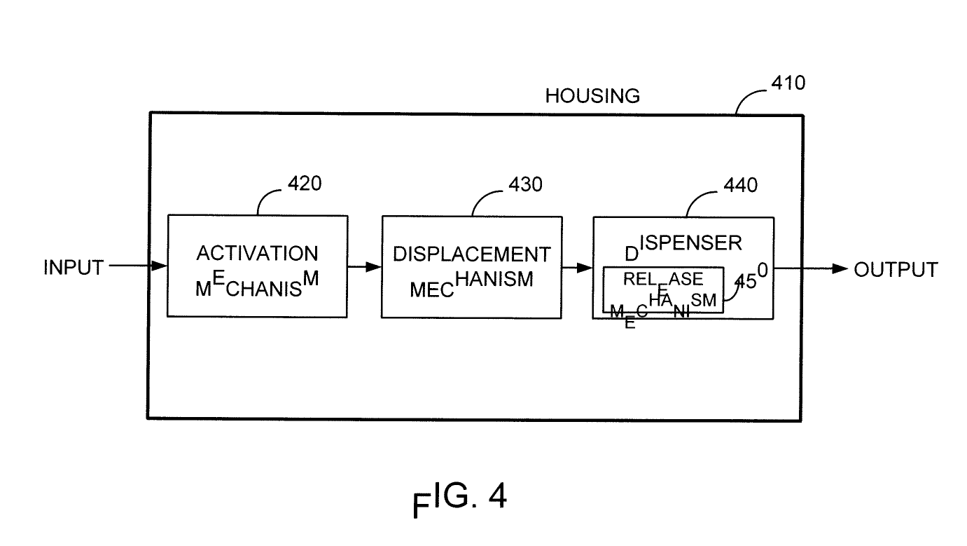

FIG. 4 is a block diagram of one embodiment of an extended reach apparatus. The apparatus includes a housing 410 integrated with an activation mechanism 420 and displacement mechanism 430 for moving a dispenser 440 in a way that activates a release mechanism of the dispenser 450, producing an output of content formerly contained in the dispenser 440. The dispenser 440 can be a container of sunscreen, moisturizing lotion, shaving cream/gel, self-tanning lotion, etc. removable from the housing 410.

An input causes the activation mechanism 420 to activate. This input can be physical movement or force on the activation mechanism 420, such as by pressing, sliding, tapping, or touching a trigger of the activation mechanism 420. The activation mechanism 420 can be a trigger, switch, button, or lever to receive the input. The activation mechanism 420, when activated, triggers a movement of the displacement mechanism 430 that displaces a position of the dispenser 440. The displacement mechanism 430 can be a lever, motor, pneumatic, hydraulic, or spring mechanism. The displacement mechanism 430 and the activation mechanism 420 can work closely together and thus be integrally formed.

The displacement mechanism 430 can actively move the dispenser 440 from a rest position (not releasing product) to a triggered position (releasing product). The displacement mechanism 430 can displace the dispenser by applying a force to the bottom end of the dispenser. The dispenser 440 contains a release mechanism 450 that controls the release of content from the dispenser 440. When the release mechanism 450 is not activated, then content in the dispenser 440 is maintained within the dispenser 440. When the release mechanism 450 is activated, then at least a portion of content in the dispenser 440 is released from the dispenser 440. This released portion of content is the output of FIG. 4. The dispenser 440 and release mechanism 450 are also operable directly by a user without the apparatus. However, the apparatus assists the user in using the dispenser 440 to apply product to hard-to-reach areas of the body.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

I claim:

1. An apparatus comprising:
a housing to secure a dispenser, the housing keyed to a release mechanism of the dispenser; and
an activation mechanism to cause the dispenser to move, the activation mechanism to activate release of contents from the dispenser.

2. The apparatus of claim 1, wherein the housing includes a head and a body, wherein the activation mechanism causes the dispenser to move towards the head.

3. The apparatus of claim 2, further comprising:
a displacement mechanism coupled to the activation mechanism, the displacement mechanism to move the dispenser in response to activation of the activation mechanism.

4. The apparatus of claim 3, wherein the displacement mechanism comprises:
a plate to apply a force to the dispenser to activate the dispenser.

5. The apparatus of claim 3, wherein the displacement mechanism includes any one of a lever mechanism, a motor, a pneumatic mechanism, a hydraulic mechanism, or a spring mechanism to move the dispenser.

6. The apparatus of claim 3, wherein the activation mechanism and the displacement mechanism are integrally formed.

7. The apparatus of claim 3, wherein the activation mechanism comprises:
an external contact;
a rotating mechanism coupled to the external contact and the displacement mechanism; and
a plurality of springs each coupled to the rotating mechanism, the plurality of springs to bias the external contact and the rotating mechanism to a rest position.

8. The apparatus of claim 2, wherein the head is removably coupled to the body to provide access to an interior chamber of the housing.

9. The apparatus of claim 1, wherein the housing defines an interior chamber to secure the dispenser with a form fit.

10. The apparatus of claim 1, wherein the activation mechanism includes any one of a trigger mechanism, a switch mechanism, a button mechanism, or a lever mechanism.

11. The apparatus of claim 1, wherein the activation mechanism activates a release mechanism of the dispenser.

12. The apparatus of claim 1, wherein the housing comprises:
a distal end through which the contents of the dispenser are released; and
a proximal end in which the activation mechanism is disposed.

13. The apparatus of claim 1, wherein the housing defines a form fitting recess to receive and align the release mechanism of the dispenser with an opening of the housing.

14. An apparatus comprising:
a dispenser;
a housing to secure the dispenser in a first position, the housing keyed to a nozzle of the dispenser; and
an activation mechanism coupled to the housing, the activation mechanism, when activated, to cause the dispenser to move from the first position to a second position, the activation mechanism, when activated, to activate release of contents from the dispenser.

15. The apparatus of claim 14, wherein the housing includes a head and a body, the head does not change position while the activation mechanism is activated.

16. The apparatus of claim 14, wherein the dispenser has a bottom edge, the nozzle and the bottom edge situated at opposite ends of the dispenser, the bottom edge to move from a first location to a second location when the activation mechanism is activated.

17. The apparatus of claim 14, wherein the dispenser is completely encompassed by the apparatus.

18. The apparatus of claim 14, wherein the activation mechanism is movable along a first axis to cause the nozzle to depress along a second axis, the first axis perpendicular to the second axis.

19. The apparatus of claim 14, further comprising: a displacement mechanism to move the dispenser from the first position to the second position to cause contents contained in the dispenser to emit through an opening defined by the housing.

20. The apparatus of claim 14, the activation mechanism comprising:
an external contact;
a rotating mechanism coupled to the external contact and the displacement mechanism; and
a plurality of springs each coupled to the rotating mechanism, the plurality of springs to bias the external contact and the rotating mechanism into a rest position.
